(19) United States
(12) Patent Application Publication
(10) Pub. No.: US 2012/0249611 A1
(43) Pub. Date: Oct. 4, 2012

(54) ELECTRONIC EQUIPMENT

(75) Inventors: Yoshinori Shibata, Osaka-shi (JP); Masami Ozaki, Osaka-shi (JP)

(73) Assignee: SHARP KABUSHIKI KAISHA, Osaka-shi, Osaka (JP)

(21) Appl. No.: 13/515,018

(22) PCT Filed: Sep. 6, 2010
(86) PCT No.: PCT/JP2010/065252

§ 371 Date: Jun. 11, 2012

(30) Foreign Application Priority Data
Dec. 15, 2009 (JP) 2009-284287

(51) Int. Cl. G09G 5/10

(52) U.S. Cl. 345/690

(57) ABSTRACT

The invention includes: an input section (5), for specifying a color gamut during photographing, which specifies a color gamut for reading information of a subject read by a reading section (2); and an input section (8) for specifying a color gamut for a display section (3) during displaying of the reading information by the display section (3). The display section (3) is capable of changing a color gamut by adjusting light intensities of respective different primary colors emitted from the display section (3). The input section (5) selects a color gamut which falls within the color gamut which the display section (3) can describe. The input section (8) selects the color gamut selected through the input section (5) as the color gamut for the display section (3).

### TECHNICAL FIELD

The present invention relates to an electronic equipment including a reading section for reading a subject and a display section for displaying reading information of the subject read by the reading section.

### BACKGROUND ART

Electronic equipments, such as digital cameras, camera-equipped mobile phones, and scanners, generally include a reading section for reading a subject and a display section allowing checking of reading information of the subject read by the reading section.

Recently, in the field of electronic equipments, especially, in the field of digital cameras, the conventionally used ordinary monitor is not only capable of handling reading information of a subject read by a reading section in compliance with the sRGB (Standard RGB) standard, one of de facto international standards for color gamut (color space), but has been also adapted to handle the information in compliance with the AdobeRGB standard to respond to consumers' demand for ever higher image quality. The AdobeRGB standard covers a far wider color gamut than the sRGB standard, is highly compatible with printing, color calibration, and like processes, and is the de facto color gamut standard in commercial printing and other fields.

Those models capable of motion images has been adapted to support the NTSC standard.

FIG. 4 is an x-y chromaticity diagram showing a visible region including all perceptible colors, the AdobeRGB color gamut, the sRGB color gamut, and the NTSC color gamut.

The visible region covers the widest color region as indicated by a horseshoe, whilst the sRGB covers the smallest color gamut as indicated by bold dashed lines.

The AdobeRGB produces a wider color gamut, indicated by bold solid lines, than the sRGB and is capable of representing those parts of colors which the sRGB cannot represent.

The bold dash-dot lines indicate the color gamut of the NTSC (National Television System Committee) broadcast standard.

Traditionally, the same sRGB standard (color gamut) was followed in the digital camera field in adjusting, for example, the reading information of a subject read by the reading section (image capturing section), the display section allowing checking of the reading information, and the printer for printing the reading information.

Therefore, there was little difference in color gamut between the image of the subject displayed on the display section and the image of the subject printed by the printer, causing no such image quality discrepancy as to be considered problematic.

Thus, one could perform a final check on an image of the subject on the display section and subsequently print the image without further modification.

However, as mentioned above, the subject reading information can now be handled in compliance with the AdobeRGB standard which covers a far wider color gamut than the sRGB standard, especially in the digital camera field. On the other hand, many display sections mounted to digital cameras to display the reading information are still designed only to support the sRGB standard.

Meanwhile, in the field of printers for printing the reading information, printers capable of a far wider color gamut than the sRGB standard are already commercially available even for home photograph printing use. In the commercial printing and other fields, the AdobeRGB standard is the de facto industrial standard.

When different color gamut standards are used for reading information of a subject read by the reading section, the display section allowing checking of the reading information, and the printer for printing the reading information as described in the foregoing, the following problems may occur.

As an example, if the subject reading information in compliance with the AdobeRGB standard is to be displayed on a display section operating with the sRGB standard, the display section can only display a degraded image of the subject because the display section cannot reproduce parts of the color gamut.

On the other hand, if the printer which prints the reading information is compatible with, for example, the AdobeRGB standard, there would be little degradation in the printed image of the subject.

Thus, there occurs image quality discrepancy between the image of the subject displayed on the display section and the printed image of the subject due to the difference in available color gamut.

In the above case, it may therefore be difficult to print an image of the subject without modification after performing a final check on the image on the display section in a conventional manner.

To address this problem, recently, AdobeRGB-compatible display sections are provided.

For example, Patent Literature 1 describes an image capturing device including a display section compatible with the AdobeRGB standard and an image capturing section which allows a selection of a target color gamut from the sRGB and AdobeRGB standards.

In this image capturing device, if the AdobeRGB color gamut is selected as the target color gamut, the target color gamut matches the color gamut of the display section; therefore, the image capturing data conforming to the AdobeRGB color gamut is sent to the display section for display without modification.

In contrast, if the sRGB color gamut is selected as the target color gamut, the target color gamut does not match the color gamut of the display section; therefore, the image capturing data conforming to the sRGB color gamut is approximately converted to image capturing data conforming to the AdobeRGB color gamut and sent to the display section for display, so that the colors which would be reproduced from the image capturing data conforming to the sRGB color gamut on a display section having properties for the sRGB color gamut can be approximately reproduced on the display section having properties for the AdobeRGB color gamut.

This arrangement allows the colors of the final image conforming to the selected target color gamut (color reproducibility) to be predicted from the display image displayed on the display section.

In addition, Patent Literature 2 describes a color reproduction device capable of reproducing colors according to with multiple color reproduction ranges (color gamuts).

The arrangement enables a single color reproduction device to reproduce colors from input color signals representing various selectable color gamuts.

### CITATION LIST

### Patent Literature

Patent Literature 1
Japanese Patent Application Publication, Tokukai, No. 2008-245248A (Published Oct. 9, 2008)
Patent Literature 2
Japanese Patent Application Publication, Tokukai, No. 2007-4129A (Published Jan. 11, 2007)

### SUMMARY OF INVENTION

### Technical Problem

The display section described in Patent Literature 1, however, has a problem. Since the display section has its color gamut fixed to one color gamut standard (AdobeRGB standard), to switch between color gamuts, the display section itself needs to be mechanically removed and replaced by another display section having a different color gamut. This is very troublesome.

In addition, according to the arrangement of Patent Literature 1, information on the color gamut of the display section is sent to the CPU for comparison with information on the selected target color gamut. This adds to undesirable circuit complexity.

FIG. 5 is a schematic drawing representing the arrangement of the color reproduction device (LED display device) having multiple color reproduction ranges (color gamuts) described in Patent Literature 2.

As illustrated in the figure, the color reproduction device is provided with a selection section 100, a color coordinate converting section 200, a color gamut adjusting section 300, a storage section 400, and a drive section 500.

If the input color signal is a non-linear color signal, the color coordinate converting section 200 performs linear correction to produce a linear color signal and subsequently converts this signal according to the color coordinates for a device-independent color gamut (CIE-XYZ color gamut).

In addition, the selection section 100 is adapted to allow a selection of the target color gamut in compliance with which colors are to be reproduced from the input color signal of which the color coordinate values have been converted by the color coordinate converting section 200.

The color gamut adjusting section 300 is provided with a calculation section 310 and a primary color determining section 320, and adjusts the color gamut of the display section (not illustrated) of the color reproduction device according to the target color gamut selected through the selection section 100.

The drive section 500 adjusts the light intensity of the light source (LEDs) of the color reproduction device so that the primary colors of the color reproduction device can be adjusted on the basis of the primary colors rearranged by the primary color determining section 320. Simultaneously, the drive section 500 adjusts the light intensity of the light source (LEDs) so that the input color signal is output after being converted to conform to the color gamut determined according to the rearranged primary colors. Colors are reproduced on the display section of the color reproduction device from the input color signal having been converted to conform to the color reproduction range determined according to the rearranged primary colors and subsequently output.

The storage section 400 stores the color coordinates for the primary colors of the light source (LEDs) of the color reproduction device, the color coordinates for the primary colors of the target color gamut, and the like.

As described in the foregoing, the color reproduction device is arranged so that the selection section 100 can allow a selection of a color gamut only for the display section of the color reproduction device. Thus, a color gamut for the input color signal needs to be selected separately.

Therefore, if the above color reproduction device is incorporated, for example, in a digital camera, it is required to separately specify a color gamut for reading information of a subject read by the reading section (image capturing section) and a color gamut for the display section to allow checking of the reading information. The specification of the former color gamut corresponds to the selection of a color gamut for the input color signal. Thus, the user needs to specify a color gamut a total of twice, which is inconvenient to the user.

The present invention, conceived in view of these problems, has an object to provide an electronic equipment which is provided with a reading section and a display section such that the single display section can display reading information in various selectable color gamuts without degradation in image quality and which also allows to specify, through a single color-range-specifying operation, both a color gamut for reading information of a subject read by the reading section and a color gamut for the display section during displaying of the reading information by the display section.

### Solution to Problem

An electronic equipment in accordance with the present invention, to address the problems, is an electronic equipment including: a reading section for reading a subject; and a display section for displaying reading information of the subject read by the reading section, the display section being capable of changing a color gamut of the display section by adjusting light intensities of respective different primary colors emitted from the display section, the electronic equipment further including: a color gamut selection section for allowing a user to select any one of color gamuts which the display section can describe; a first color gamut specifying section for specifying a color gamut selected by the user as a color gamut for the reading information; and a second color gamut specifying section for specifying the color gamut selected by the user as a color gamut for the display section during displaying of the reading information by the display section.

According to the arrangement, the color gamut specified by the first color gamut specifying section for specifying a color gamut for the reading information of a subject read by the reading section is also specified straight away as a color gamut for the display section by the second color gamut specifying section for specifying a color gamut for the display section during displaying of the reading information by the display section.

In other words, the color gamut for the display section is specified in conjunction with the specification of the color gamut by the first color gamut specifying section for specifying a color gamut for the reading information of the subject read by the reading section.

Therefore, the electronic equipment provided with a reading section, such as a digital camera or a display-section-equipped scanner, which is arranged as above and a display section for displaying reading information of a subject read by the reading section does not require a color gamut to be separately specified twice, i.e., a color gamut for the subject reading information and a color gamut for the display section to allow checking of the reading information, unlike the conventional arrangements. The electronic equipment can hence alleviate inconvenience in the user's operationality.

Furthermore, the first color gamut specifying section only allows specification of a color gamut which falls within the color gamut which the display section can describe. Hence, the single display section can display, without causing degradation in image quality, the subject reading information with various color gamuts each of which is specified through the first color gamut specifying section.

### Advantageous Effects of Invention

As described in the foregoing, an electronic equipment in accordance with the present invention is arranged so that the display section is capable of changing a color gamut of the display section by adjusting light intensities of respective different primary colors emitted from the display section, and that the electronic equipment includes: a color gamut selection section for allowing a user to select any one of color gamuts which the display section can describe; a first color gamut specifying section for specifying a color gamut selected by the user as a color gamut for the reading information; and a second color gamut specifying section for specifying the color gamut selected by the user as a color gamut for the display section during displaying of the reading information by the display section.

With the arrangement, an electronic equipment including the reading section and the display section is provided such that both a color gamut for the reading information and a color gamut for the display section during displaying of the reading information by the display section can be specified through a single color-range-specifying operation and also that the single display section can display the reading information in various selectable color gamuts without degradation in image quality.

### BRIEF DESCRIPTION OF DRAWINGS

FIG. 1

FIG. 1 is a block diagram of an image capturing device in accordance with an embodiment of the present invention.

FIG. 2

FIG. 2 is a drawing showing a schematic of an image capturing device in accordance with an embodiment of the present invention.

FIG. 3

FIG. 3 is a block diagram of an image capturing device in accordance with another embodiment of the present invention.

FIG. 4

FIG. 4 is an x-y chromaticity diagram showing the visible color range, the sRGB color gamut, the AdobeRGB color gamut, and the NTSC color gamut.

FIG. 5

FIG. 5 is a block diagram of a conventional color reproduction device having multiple color reproduction ranges.

### DESCRIPTION OF EMBODIMENTS

The following will describe embodiments of the present invention in detail in reference to drawings. The dimensions, materials, shapes, and relative configurations of the members described in the embodiments are, however, illustrative only and therefore should by no means be interpreted as limiting the scope of the invention.

### Embodiment 1

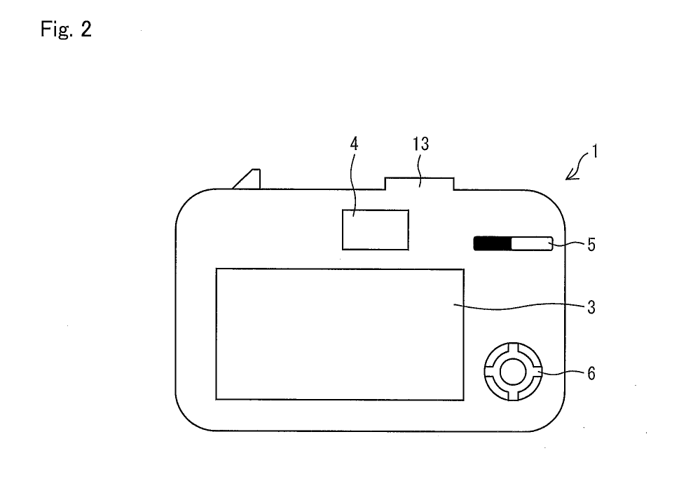

Referring to FIG. 2, the following will briefly describe an arrangement of an image capturing device (digital camera) 1, which is an example of an electronic equipment in accordance with the present invention.

Although embodiment 1 will be described below with the use of the image capturing device 1, the electronic equipment in accordance with the present invention is not limited to this, provided that it includes (i) a reading section (image capturing section) for reading a subject and (ii) a display section for displaying information of the subject read by the reading section. The electronic equipment can thus be embodied in many ways. Examples of the electronic equipment encompass a camera-equipped mobile phone and a display-equipped scanner.

The image capturing device 1 includes: (i) an image capturing section 2 (not illustrated), capable of capturing an image of a subject, which is provided with (a) a camera lens provided on the opposite side of the display section (see FIG. 2) of the image capturing device 1 and (b) image capturing elements, such as CCDs or CMOSs; (ii) a display section 3 constituted by a color liquid crystal display device for displaying image capturing information of the subject read by the image capturing section 2 by reading the subject; (iii) a viewfinder 4; (iv) an input section 5 for specifying a color gamut during photographing (color gamut selection section, first color gamut specifying section); (v) an input section 6 for specifying a white balance during photographing (white balance selection section, first white balance specifying section); and (vi) a shutter 13.

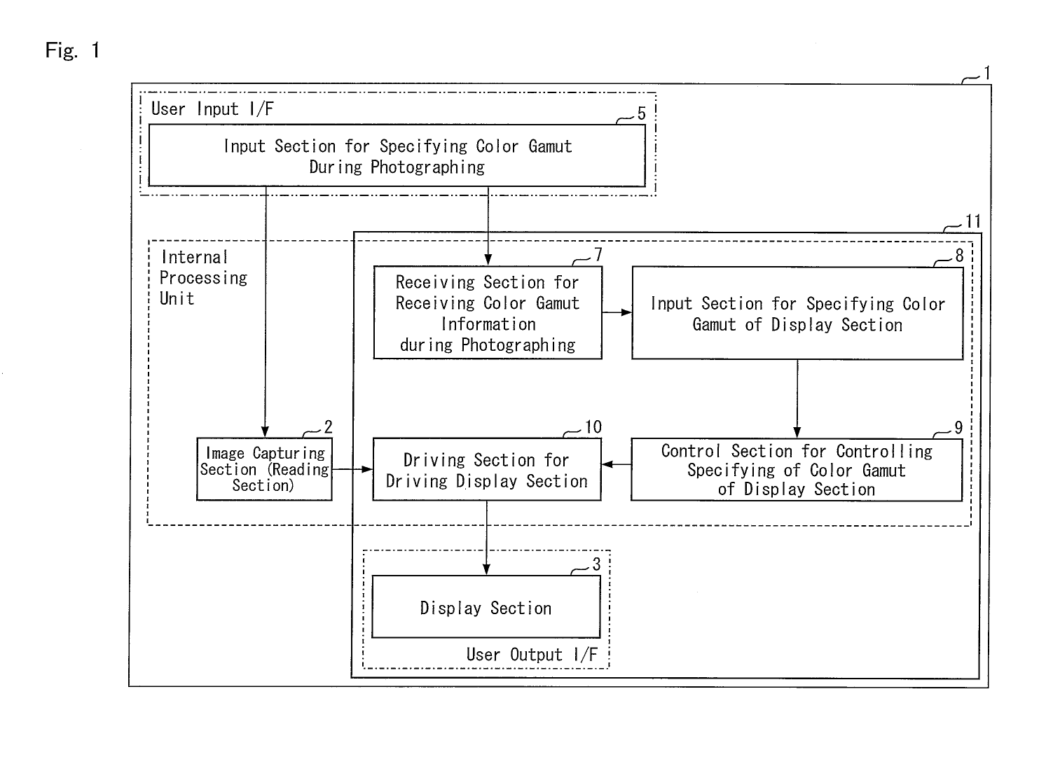

FIG. 1 is block diagram of an image capturing device 1 with no function of specifying a white balance of the display section. Referring to FIG. 1, the following will describe each arrangement of the image capturing device 1 in more detail.

Light, which is reflected from the subject and has passed through the camera lens of the image capturing section 2 forms an image on the image capturing element via various optical filters. In Embodiment 1, an array of CCDs is employed as the image capturing elements.

The image capturing element has a light-receiving surface on which light sensors such as photodiodes are provided. A red, green, or blue color filter, for example, is provided for each of the light sensors in a predetermined layout.

In the image capturing section 2, the light, which has formed an image on the image capturing element, is converted by the light sensors to electric charges which vary in accordance with the intensities of incident light, and are then stored. The electric charges thus stored are sequentially converted to voltage signals by driving the respective image capturing elements with the use of row and column drivers.

The voltage signals are converted to respective digital signals by an A/D converter to produce image capturing information (reading information, image data) on the subject.

The input section 5 allows a selection of either an sRGB color gamut or an AdobeRGB color gamut in response to a select key operation (see FIG. 2).

According to Embodiment 1, the color gamut is specified during photographing by selecting either the sRGB color gamut or the AdobeRGB color gamut. Embodiment 1 is, however, by no means limited to a specific color gamut, provided that the color gamut falls within a color gamut which the display section 3 can describe. Examples of the color gamut can encompass an NTSC color gamut and a color gamut specified by the user (any color gamut which can be specified by the user). The number of selectable color gamuts is also not limited to a specific number.

The color gamut during photographing is specified by using a select key in Embodiment 1. Embodiment 1 is, however, not limited to this. Alternatively, a configuration can be employed in which a display section 3 with a touch panel is provided so that the display section 3 can display a color gamut selection screen and a selection of a color gamut can be made by directly touching the display section 3.

As illustrated in FIG. 1, information on the color gamut selected through the input section 5 is sent to both the image capturing section 2 and a receiving section 7 for receiving color gamut information during photographing (color gamut information receiving section).

Therefore, for example, if the AdobeRGB color gamut is selected through the input section 5, then the image capturing section 2 produces image capturing information conforming to the AdobeRGB color gamut and sends the information to a driving section 10 for driving the display section 3.

On the other hand, if the sRGB color gamut is selected, then the image capturing section 2 produces image capturing information conforming to the sRGB color gamut and sends the information to the driving section 10.

Note that according to the present embodiment, if the user has not specified a color gamut during photographing, then the sRGB color gamut, for example, is selected as the default (initial settings before shipment).

In Embodiment 1, the input section 5 functions as (i) the color gamut selection section allowing the user to select a color gamut and (ii) a first color gamut specifying section allowing the color gamut selected by the user to be set as a color gamut for the reading information. Embodiment 1 is, however, not limited to this. Alternatively, the input section 5 can merely function as the color gamut selection section, whereas a separate member carries out the function of the first color gamut specifying section.

The receiving section 7 receives the information on the selected color gamut from the input section 5, and then sends the information to an input section 8 (second color gamut specifying section) for a specifying color gamut of the display section 3.

The input section 8 specifies a color gamut of the display section 3 on the basis of the information on the color gamut which is selected through the input section 5 and is sent from the receiving section 7.

For example, if the sRGB color gamut is selected through the input section 5, then the sRGB color gamut is also selected through the input section 8. If the AdobeRGB color gamut is selected through the input section 5, then the AdobeRGB color gamut is selected through the input section 8.

In short, the input section 5 and the input section 8 specify a color gamut in conjunction with each other.

Information on the color gamut selected via the input section 8 is then sent to a control section 9 for controlling the specifying of the color gamut of the display section 3.

It is possible to employ, as the display section 3, a liquid crystal display device with a backlight including light-emitting diodes (LEDs) which emit light of respective different primary colors.

In Embodiment 1, a liquid crystal display device, which includes a backlight having red, green, and blue LEDs, is used as the display section 3.

The color LEDs in the liquid crystal display device are adjusted in terms of their output light intensities and color filters so that the liquid crystal display device can describe the AdobeRGB color gamut which is wider than the sRGB color gamut.

Note that cyan, yellow, and magenta LEDs can be further employed as complementary color LEDs where necessary, apart from the red, green, and blue LEDs.

Likewise, in the color filters, cyan, yellow, and magenta filters can be further employed as complementary color filters where necessary, apart from the red, green, and blue color filters.

The liquid crystal display device can convert the AdobeRGB color gamut to the sRGB color gamut and vice versa, by adjusting the output light intensities of the respective color LEDs.

The output light intensities of the respective color LEDs can be adjusted by controlling the color LEDs by PWM (Pulse Width Modulation) or AM (Amplitude Modulation), for example.

According to Embodiment 1, the liquid crystal display device converts the AdobeRGB color gamut to the sRGB color gamut and vice versa, by adjusting the output light intensities of the respective color LEDs. Embodiment 1 is, however, not limited to this. Alternatively, the liquid crystal display device can also convert the AdobeRGB color gamut to the sRGB color gamut and vice versa, by (i) adjusting the output light intensities of the respective color LEDs so that the liquid crystal display device can describe the AdobeRGB color gamut and (ii) adjusting a voltage to be applied across a liquid crystal layer of a liquid crystal display panel in the liquid crystal display device to adjust light intensities passing through the respective red, green, and blue color filters (intensities of light with which the respective color filters are irradiated).

According to Embodiment 1, the liquid crystal display device is used as the display section 3. Embodiment 1 is, however, not limited to this. Alternatively, it is possible to employ a display device, such as an organic EL display device, which includes light-emitting layers for emitting light of respective different primary colors.

The control section 9 has a memory (not illustrated). The memory stores, in the form of a lookup table, data related to the output light intensities of the respective color LEDs (mix ratios of the light intensities of the respective color LEDs) for each color gamut (the sRGB color gamut or the AdobeRGB color gamut) that is selectable via the input section 8. By using such data, the output light intensities of the respective red, green, and blue LEDs in the backlight of the liquid crystal display device can be adjusted so as to produce primary colors for the sRGB color gamut or the AdobeRGB color gamut.

As described in, for example, Patent Literature 2 (Japanese Patent Application Publication, Tokukai, No. 2007-4129A), it is possible to calculate the data related to the output light intensities of the respective color LEDs (mix ratios of the light intensities of the respective color LEDs), by using (i) a colorimetric display model using (a) color coordinates for the red, green, and blue LEDs in the backlight of the liquid crystal display device (color coordinates for the primary colors of the display section 3) and (b) the white tristimulus values and (ii) a colorimetric display model using (c) color coordinates for the primary colors for the sRGB color gamut or the AdobeRGB color gamut and (d) the white tristimulus values.

Therefore, for example, in a case where the AdobeRGB color gamut is selected via the input section 8, the data, related to the output light intensities of the respective color LEDs (mix ratios of the light intensities of the respective color LEDs) which data allows the primary colors for the AdobeRGB color gamut to be produced, is supplied to an LED control circuit in the driving section 10 from the memory in the control section 9.

The liquid crystal panel in the liquid crystal display device includes the driving section 10 which is provided with a gate driver circuit and a source driver circuit for displaying the image capturing information supplied from the image capturing section 2 or a memory (not shown) for storing image capturing information.

Furthermore, the driving section 10 includes the LED control circuit for controlling the red, green, and blue LEDs in the backlight of the liquid crystal display device.

Hence, the data related to the output light intensities of the respective color LEDs (mix ratios of the light intensities of the respective color LEDs) is sent to the LED control circuit in the driving section 10, whereas the image capturing information is sent to the source driver circuit in the driving section 10.

The image capturing information and the LED control signal are sent from the driving section 10 to the display section 3 so that the image capturing information can be displayed on a display surface of the display section 3.

According to the arrangement, the image capturing device 1 does not require a color gamut to be separately specified twice, i.e., a color gamut for the image capturing section 2 and a color gamut for the display section 3, unlike the conventional arrangements. The image capturing device 1 can hence alleviate inconvenience in the user's operationality.

Furthermore, the input section 5 allows a selection of a color gamut which falls within the color gamut which the display section 3 can describe. Hence, the single display section 3 can display, without causing degradation in image quality, image capturing information with various color gamuts each of which is selected through the input section 5.

In other words, according to the arrangement, it is possible that an appearance, which the user of the image capturing device 1 intends to obtain, is reflected in an appearance of the display on the display section 3.

According to the arrangement, it is also possible to store, in storage means such as a memory (not illustrated), the image capturing information which is being displayed on the display section 3, by pressing the shutter 13 of the image capturing device 1 illustrated in FIG. 2 while viewing the image capturing information on the display section 3 (live view).

As shown in FIG. 1, the input section 5 serves as a user input I/F, and the display section 3 serves as a user output I/F. The other elements shown in FIG. 1 carries out internal processing in the image capturing device 1.

In Embodiment 1, the display device 11 which is removable from the image capturing device 1 includes the display section 3, the receiving section 7, the input section 8, the control section 9, and the driving section 10.

### Embodiment 2

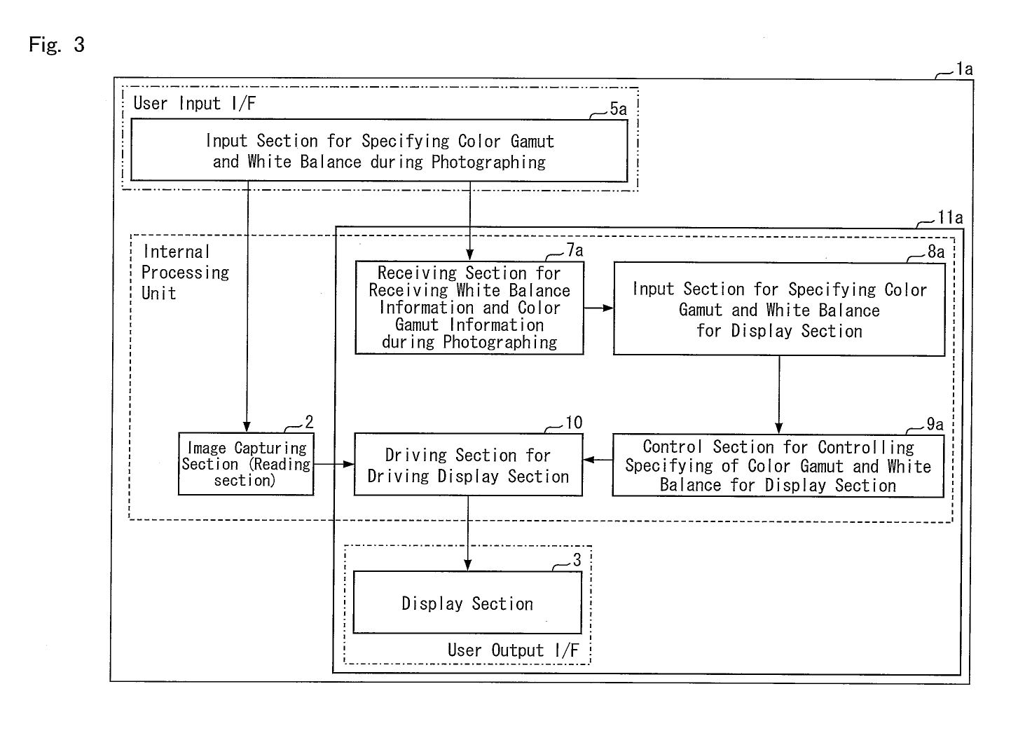

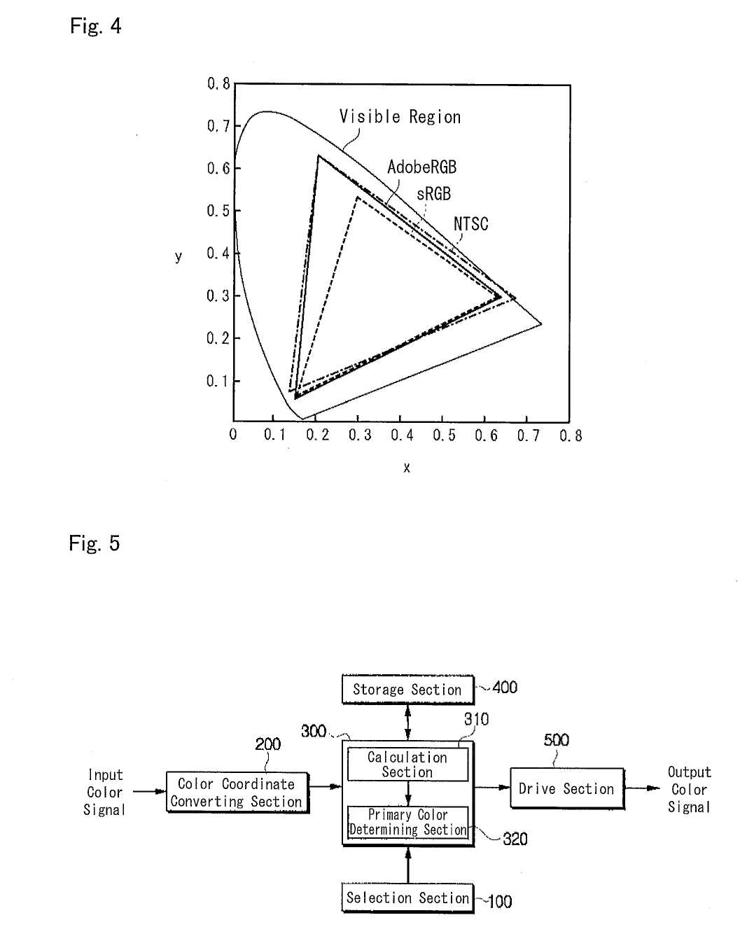

Referring to FIG. 3, Embodiment 2 of the present invention will be described below. Embodiment 2 differs from Embodiment 1 in that (i) a color gamut is specified for a display section 3 in conjunction with a color gamut being specified during photographing, and (ii) a white balance is specified for the display section 3 in conjunction with a white balance being specified during photographing. Embodiment 2 is otherwise arranged as has been described in Embodiment 1. For convenience, members of Embodiment 2 that have the same functions as those in the figures for Embodiment 1 are indicated by the same symbols and/or reference numerals, and their descriptions are omitted.

FIG. 3 is a block diagram of an image capturing device 1a which can set a white balance via the display section 3.

As illustrated in FIG. 3, an input section 5a for specifying, during photographing, (a) a color gamut and (b) a white balance, sends, to an image capturing section 2 and a receiving section 7a for receiving (a′) white balance information and (b′) a color gamut information during photographing, (i) information on a color gamut selected via an input section 5 for specifying a color gamut during the photographing and (ii) information on a white balance selected via an input section 6 for specifying a white balance during the photographing (white balance selection section, first white balance specifying section). Note that the input section 5 and the input section 6 are illustrated in FIG. 2.

In Embodiment 2, the input section 6 (see FIG. 2) functions as (i) the white balance selection section allowing the user to select a white balance and (ii) the first white balance specifying section for specifying the white balance selected by the user as a color gamut for reading information. Embodiment 2 is, however, not limited to this. Alternatively, the input section 6 can merely function as the white balance selection section, whereas a separate member carries out the function of the first white balance specifying section.

Via the input section 6, it is possible to select a mode in conformity with external light conditions from modes such as a sunlight mode, a fluorescent tube mode, and an electric bulb mode.

As illustrated in FIG. 3, the information on the color gamut and the white balance selected through the input section 5a is sent to the receiving section 7a.

Via an input section 8a (second white balance specifying section) for specifying (a) a color gamut and (b) white balance for a display section, a color gamut and a white balance for the display section 3 are specified on the basis of the information on the color gamut and the white balance sent from the receiving section 7a.

In other words, a color gamut and a white balance for the display section 3 are specified via the input section 8a, in conjunction with a color gamut and a white balance being specified via the input section 5a.

A control section 9a for controlling the specifying of color gamut and white balance for the display section has a memory (not shown). The memory stores, in the form of a lookup table, first and second data for each of color gamut and white balance that are selectable via the input section 8a. The first data relates to output light intensities of respective color LEDs (mix ratios of light intensities of the respective color LEDs) which allow primary colors for the selected color to be produced by adjusting the output light intensities of the respective red, green, and blue LEDs in a backlight of a liquid crystal display device. The second data relates to output light intensities of the respective color LEDs which allow a white correction to be made in accordance with the selected white balance.

Therefore, Embodiment 2 is configured so that the first data and the second data are read out from the memory in the control section 9a by an LED control circuit in a driving section 10 for driving the display section.

The information on the color gamut during photographing and white balance during photographing is sent from the input section 5a to the image capturing section 2. The image capturing section 2 produces image capturing information on the color gamut and white balance selected during photographing, and then sends the information to the driving section 10.

According to the arrangement, the image capturing device 1a does not require a color gamut and a white balance to be separately specified twice, i.e., a color gamut and a white balance for the image capturing section 2 and a color gamut and a white balance for the display section 3 to allow checking of the image capturing information of the subject read by the image capturing section 2, unlike the conventional arrangements. The image capturing device 1a can hence alleviate inconvenience in the user's operationality.

As illustrated in FIG. 3, the input section 5a serves as a user input I/F, and the display section 3 serves as a user output I/F. The other elements illustrated in FIG. 3 carry out internal processing in the image capturing device 1a.

In Embodiment 2, the display device 11a which is removable from the image capturing device 1a includes the display section 3, the receiving section 7a, the input section 8a, the control section 9a, and the driving section 10.

In the electronic equipment in accordance with the present invention, preferably, the reading information for which the color gamut is specified by the first color gamut specifying section is supplied to the display section.

According to the arrangement, the color gamut for the reading information of the subject read by the reading section, the color gamut being specified by the first color gamut specifying section, always matches the color gamut for the display section specified by the second color gamut specifying section.

Therefore, with the reading information being supplied to the display section without further modification, the display section can display, without causing degradation in image quality, the subject reading information with various color gamuts each of which is selected through the first color gamut specifying section.

In contrast, conventionally, the color gamut for the subject reading information does not necessarily match the color gamut for the display section. Therefore, the reading information may in some cases need to be converted to conform to the color gamut for the display section before being supplied to the display section.

In the electronic equipment in accordance with the present invention, preferably, the color gamut selection section allows the user to select an sRGB color gamut, an AdobeRGB color gamut, or an NTSC color gamut

According to the arrangement, the color gamut for the reading information and the color gamut for the display section are identically any one of the sRGB standard, which is one of de facto international standards for color gamut conventionally used, for example, in general monitors, the AdobeRGB standard, which covers a far wider color gamut than the sRGB standard, is highly compatible with printing, color calibration, and like processes, and is the de facto color gamut standard in commercial printing and other fields, and the NTSC standard, which is one of de facto broadcast color gamut standards.

Therefore, the single display section can display the reading information with one of the sRGB color gamut, the AdobeRGB color gamut, and the NTSC color gamut without degradation in image quality.

In the electronic equipment in accordance with the present invention, preferably, the color gamut selection section allows the user to further select any color gamut which the user can specify.

According to the arrangement, the user can specify any color gamut. Therefore, the color gamut selection section may allow the user to further select any color gamut specified by the user.

Therefore, an electronic equipment may be provided which offers a greater range of selectable color gamuts.

In the electronic equipment in accordance with the present invention, preferably, the electronic equipment further comprises a color gamut information receiving section for receiving, from the first color gamut specifying section, information on the color gamut selected by the user; and the color gamut information receiving section and the second color gamut specifying section are provided in a display device which includes the display section.

In the electronic equipment in accordance with the present invention, preferably, the display section is capable of changing a white balance by adjusting the light intensities of the respective different primary colors emitted from the display section; and electronic equipment further comprises: a white balance selection section for allowing the user to select a white balance for the reading information; a first white balance specifying section for specifying the white balance selected by the user as a white balance for the reading information; and a second white balance specifying section for specifying the white balance selected by the user as a white balance for the display section during displaying of the reading information by the display section.

According to the arrangement, the white balance specified by the first white balance specifying section for specifying a white balance for the reading information is also specified straight away as a white balance for the display section by the second white balance specifying section for specifying a white balance for the display section during displaying of the reading information by the display section.

In other words, the white balance for the display section is specified in conjunction with the specification of the white balance by the first white balance specifying section for specifying a white balance for the reading information.

Therefore, the electronic equipment provided with a reading section, such as a digital camera or a display-section-equipped scanner, which is arranged as above and a display section for displaying reading information of a subject read by the reading section does not require a white balance to be separately specified twice, i.e., a white balance for the reading information and a white balance for the display section to allow checking of the reading information, unlike the conventional arrangements. The electronic equipment can hence alleviate inconvenience in the user's operationality.

In the electronic equipment in accordance with the present invention, preferably, the electronic equipment further comprises a white balance information receiving section for receiving, from the first white balance specifying section, information on the white balance specified by the first white balance specifying section; and the white balance information receiving section and the second white balance specifying section are provided in a display device which includes the display section.

In the electronic equipment in accordance with the present invention, preferably, the reading section is an image capturing section.

According to the arrangement, the reading section is, for example, an image capturing section which includes a lens and image capturing elements, such as CCDs or CMOSs, and which is capable of capturing an image of a subject.

An electronic equipment, such as a digital camera, which includes this image capturing section, is often used with a printer or the like that is compatible with, for example, the AdobeRGB color gamut which is a wider color gamut than that of the image capturing information of the subject read by the image capturing section, to print the information.

Therefore, according to the arrangement, the image capturing information of the subject read by the image capturing section can be printed by the printer without modification after a final check is performed on the information on the display section.

In the electronic equipment in accordance with the present invention, preferably, the display section includes: color filters of respective different primary colors; and a liquid crystal layer capable of adjusting intensity of light with which the respective color filters are irradiated.

According to the arrangement, a liquid crystal display panel including color filters of respective different primary colors and a liquid crystal layer capable of adjusting intensity of light with which the respective color filters are irradiated may be used as the display section.

In the electronic equipment in accordance with the present invention, preferably, the display section includes a backlight having light-emitting diodes each emitting light of a corresponding one of different primary colors.

According to the arrangement, for example, a liquid crystal display device including a backlight having light-emitting diodes emitting light of respective different primary colors may be used as the display section.

Although the description took a liquid crystal display device as an example of a display device including a backlight having light-emitting diodes emitting light of respective different primary colors, this is not the only possibility.

In the electronic equipment in accordance with the present invention, preferably, the display section includes light-emitting layers each emitting light of a corresponding one of different primary colors.

According to the arrangement, for example, an organic EL display device which includes light-emitting layers each emitting light of a corresponding one of different primary colors may be used as the display section.

Although the description took an organic EL display device as an example of a display device including light-emitting layers each emitting light of a corresponding one of different primary colors, this is not the only possibility.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to an electronic equipment including a reading section for reading a subject and a display section for displaying reading information of the subject read by the reading section.

### REFERENCE SIGNS LIST

1, 1a Image Capturing Device (Electronic equipment)
2 Image Capturing Section (Reading Section)
3 Display Section
5 Input Section for Specifying Color Gamut during Photographing (Color Gamut Selection Section, First Color Gamut Specifying Section)
6 Input Section for Specifying White Balance
7 Receiving Section for Receiving Color Gamut Information during Photographing (Color Gamut Information

### Receiving Section)

7a Receiving Section for Receiving White Balance Information and Color Gamut Information during Photographing
8 Input Section for Specifying Color Gamut of Display Section (Second Color Gamut Specifying Section)
8a Input Section for Specifying Color Gamut and White Balance for Display Section
10 Driving Section for Driving Display Section
11, 11a Display Device

1. An electronic equipment, comprising:
a reading section for reading a subject; and
a display section for displaying reading information of the subject read by the reading section,
the display section being capable of changing a color gamut of the display section by adjusting light intensities of respective different primary colors emitted from the display section,
said electronic equipment further comprising:
a color gamut selection section for allowing a user to select any one of color gamuts which the display section can describe;
a first color gamut specifying section for specifying a color gamut selected by the user as a color gamut for the reading information; and
a second color gamut specifying section for specifying the color gamut selected by the user as a color gamut for the display section during displaying of the reading information by the display section.

2. An electronic equipment as set forth in claim 1, wherein the reading information for which the color gamut is specified by the first color gamut specifying section is supplied to the display section.

3. An electronic equipment as set forth in claim 1, wherein the color gamut selection section allows the user to select an sRGB color gamut, an AdobeRGB color gamut, or an NTSC color gamut.

4. An electronic equipment as set forth in claim 3, wherein the color gamut selection section allows the user to further select any color gamut which the user can specify.

5. An electronic equipment as set forth in claim 1, further comprising a color gamut information receiving section for receiving, from the first color gamut specifying section, information on the color gamut selected by the user,
the color gamut information receiving section and the second color gamut specifying section being provided in a display device which includes the display section.

6. An electronic equipment as set forth in claim 1,
the display section being capable of changing a white balance by adjusting the light intensities of the respective different primary colors emitted from the display section,
said electronic equipment further comprising:
a white balance selection section for allowing the user to select a white balance for the reading information;
a first white balance specifying section for specifying the white balance selected by the user as a white balance for the reading information; and
a second white balance specifying section for specifying the white balance selected by the user as a white balance for the display section during displaying of the reading information by the display section.

7. An electronic equipment as set forth in claim 6, further comprising a white balance information receiving section for receiving, from the first white balance specifying section, information on the white balance specified by the first white balance specifying section,
the white balance information receiving section and the second white balance specifying section being provided in a display device which includes the display section.

8. An electronic equipment as set forth in claim 1, wherein the reading section is an image capturing section.

9. An electronic equipment as set forth in claim 1, wherein:
the display section includes:
color filters of respective different primary colors; and
a liquid crystal layer capable of adjusting intensity of light with which the respective color filters are irradiated.

10. An electronic equipment as set forth in claim 1, wherein the display section includes a backlight having light-emitting diodes each emitting light of a corresponding one of different primary colors.

11. An electronic equipment as set forth in claim 1, wherein the display section includes light-emitting layers each emitting light of a corresponding one of different primary colors.
